(19) United States
(12) Patent Application Publication
(10) Pub. No.: US 2010/0092236 A1
(43) Pub. Date: Apr. 15, 2010

(54) Multipurpose Fixing Device for Supporting Sticks

(76) Inventor: Bok-Sung Kang, Seoul (KR)

Correspondence Address: The Marbury Law Group, PLLC, 11800 SUNRISE VALLEY DRIVE, SUITE 1000, RESTON, VA, 20191, US

(21) Appl. No.: 11/993,751

(22) PCT Filed: Jun. 26, 2006
(86) PCT No.: PCT/KR2006/002448

§ 371 Date: Dec. 21, 2007

(30) Foreign Application Priority Data
Jun. 25, 2005 (KR) 20-2005-0018418
Nov. 4, 2005 (KR) 10-2005-0105561

(51) Int. Cl. F16B 7/00

(52) U.S. Cl. 403/170

(57) ABSTRACT

Disclosed herein is a fixing device for supporting sticks. The fixing device includes a vertical stick, a horizontal stick coupled to the vertical stick, a pair of first fixing units, a pair of second fixing units, and fastening means. Each first fixing unit has a horizontal coupling part coming into close contact with the horizontal stick, and vertical coupling parts which are provided on an end of the horizontal coupling part, come into close contact with the vertical stick, and have a space defined therebetween. Each second fixing unit has a vertical coupling part which is inserted into the space of each of the first fixing units and comes into close contact with the vertical stick, and a horizontal coupling part protruding outwards from the vertical coupling part. The fastening means fasten the first fixing units and the second fixing units.

### TECHNICAL FIELD

The present invention relates generally to a multipurpose fixing device for supporting sticks and, more particularly, to a multipurpose fixing device for supporting sticks, which functions to fix horizontal sticks of a rack and adjust the installation angle of the horizontal sticks, thus allowing the rack to be smoothly installed, and which can be applied to various structures requiring a fixing device at a joint portion, as well as to the rack, thus allowing the installation angle of the supporting sticks to be adjusted as desired, like the fixing device for the supporting sticks of the rack, and adjusting the size of the structure to be constructed.

### BACKGROUND ART

Generally, various types of racks, which are inexpensive and are convenient to install, are kept in homes or clothing stores. Each rack includes a vertical stick which serves as a support, and a horizontal stick which is coupled to the vertical stick and performs the function of a rack.

Such a rack uses a fixing device having various shapes, including a “ [symbol] ” shape, a “ [symbol] ” shape, or a “ [symbol] ” shape, so as to couple the horizontal stick to the vertical stick.

The rack using the fixing device has excellent structural stability. However, it is impossible to adjust the angle of the horizontal stick.

When a user desires to install the rack at a corner or a curved portion of a wall using the conventional fixing device, adjustment of the angle of the fixing device is impossible. Thereby, several racks must he coupled and used, thus causing inconvenience to the user.

Further, when the racks arc coupled and used, the racks must be fixed using several types of fixing devices so as to secure structural stability. Since the racks must be coupled and used, it is inconvenient to install and carry the racks.

Moreover, racks exceeding a required number are purchased, thus increasing the purchase cost of racks.

In order to solve the problems of a conventional rack, Korean U.M. Appln. No. 2005-18418 was proposed and filed by the present applicant and discloses a fixing device for a horizontal stick of a rack. The fixing device is used exclusively for the rack, so that the use of the fixing device is limited. Thus, the fixing device cannot be used for a structure, such as a tent or a vinyl house, which requires a fixing device at a joint portion, so that the advantages of the fixing device for a rack according to the utility model may not be applied to other structures.

### DISCLOSURE OF INVENTION

### Technical Problem

Accordingly, the present invention has been made keeping in mind the above problems occurring in the prior art, and an object of the present invention is to provide a fixing device for supporting sticks of racks, in which the angle of fixing units secured to a vertical stick is adjustable, so that horizontal sticks are installed after the angle of the fixing units secured to the vertical stick is adjusted as desired, and which allows the fixing units to he conveniently attached to or detached from each other.

Another object of the present invention is to provide a fixing device for supporting sticks of racks, which can be conveniently and smoothly installed regardless of the place where the racks are installed, and allows a user to adjust the height of horizontal sticks as desired.

A further object of the present invention is to provide a multipurpose fixing device for supporting sticks, which is applied to various structures requiring a fixing device at a joint portion, as well as to a rack, thus allowing the installation angle of the supporting sticks to be adjusted as desired, like the fixing device for the supporting sticks of the rack, and adjusting the size of a structure to be constructed.

### Technical Solution

In order to accomplish the above objects, the present invention provides a fixing device for supporting sticks, including a vertical stick serving as a support, a horizontal stick coupled to the vertical stick and serving as a rack, a pair of first fixing units each having a horizontal coupling part which comes into close contact with the horizontal stick, and vertical coupling parts which are provided on an end of the horizontal coupling part to be located at upper and lower positions thereof, come into close contact with the vertical stick, and have a space defined therebetween, a pair of second fixing units each having a vertical coupling part which is inserted into the space of each of the first fixing units and comes into close contact with the vertical stick, and a horizontal coupling part protruding outwards from the vertical coupling part, and fastening means for fastening the first fixing units to each other and fastening the second fixing units to each other, thus joining the horizontal stick with the vertical stick.

Further, the present invention provides a fixing device for supporting sticks, including a pair of first fixing units each having a first coupling part coming into close contact with a first supporting stick, and a second coupling part provided on an end of the first coupling part to come into close contact with a second supporting stick and having a space defined thereon, a pair of second fixing units each having a first coupling part coming into close contact with a third supporting stick, a second co upling part inserted into the space of each of the first fixing units to come into close contact with the second supporting stick, the first coupling part protruding outwards from the second coupling part, and a pair of third fixing units installed at an angle different from that of the second fixing units, each of the third fixing units having a first coupling part coming into close contact with a fourth supporting stick, and a second coupling part inserted into the space of each of the first fixing units to come into close contact with the second supporting stick, the first coupling part protruding outwards from the second coupling part, and fastening means for fastening the first fixing units to each other, fastening the second fixing units to each other, and fastening the third fixing units to each other, thus joining the supporting sticks with each other.

The fixing device further includes a locking protrusion provided on an inner surface of each of the horizontal and vertical coupling parts or an inner surface of each of the first and second coupling parts, and a locking hole provided in each of the vertical and horizontal sticks or each of the first, second, third, and fourth sticks to correspond to the locking protrusion, when a fastening operation is performed using the fastening means.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing a fixing device for supporting sticks, according to an embodiment of the present invention;

FIG. 2 is a perspective view showing the fixing device for supporting sticks of FIG. 1 in the assembled state;

FIG. 3 is a front sectional view showing the fixing device for supporting sticks of FIG. 2;

FIG. 4 is a plan sectional view showing the fixing device for supporting sticks of FIG. 2;

FIG. 5 is a view showing the fixing device for supporting sticks of FIG. 1 in use;

FIG. 6 is an exploded perspective view showing a fixing device for supporting sticks, according to another embodiment of the present invention;

FIG. 7 is a perspective view showing the fixing device for supporting sticks of FIG. 6 in the assembled state; and

FIG. 8 is a view showing the fixing device for supporting sticks of FIG. 6 in use.

### MODE FOR THE INVENTION

Reference now should be made to the drawings, in which the same reference numerals are used throughout the different drawings to designate the same or similar components.

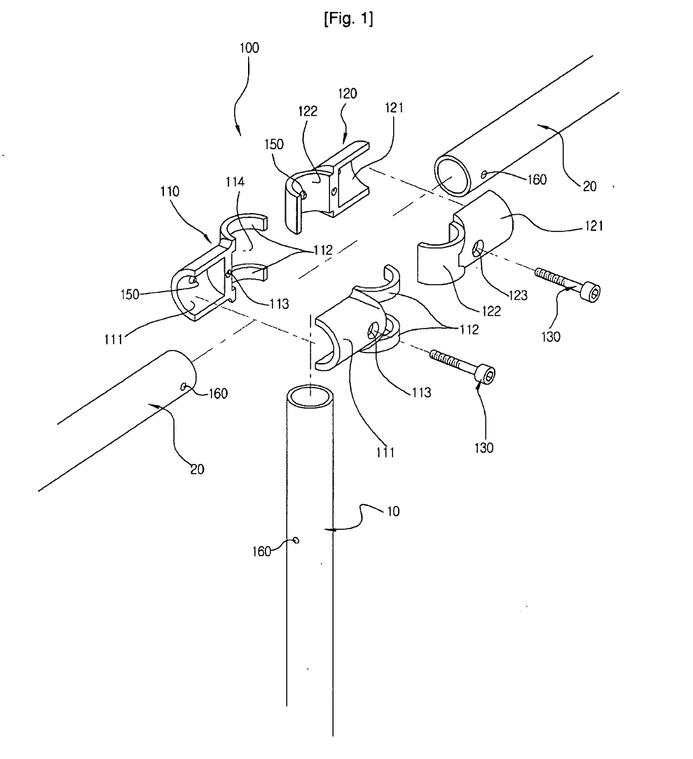

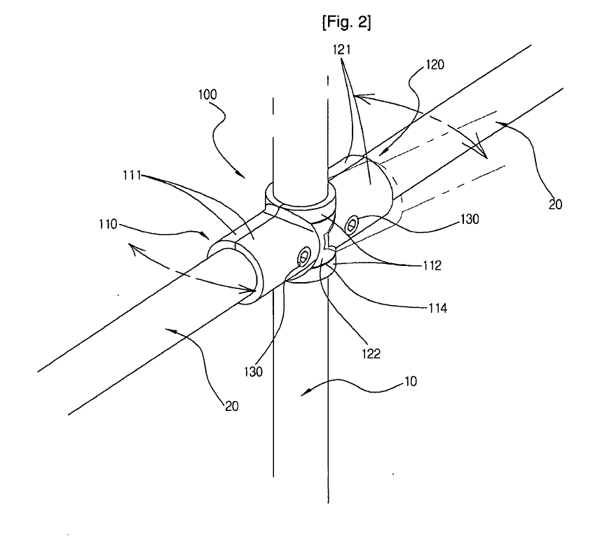

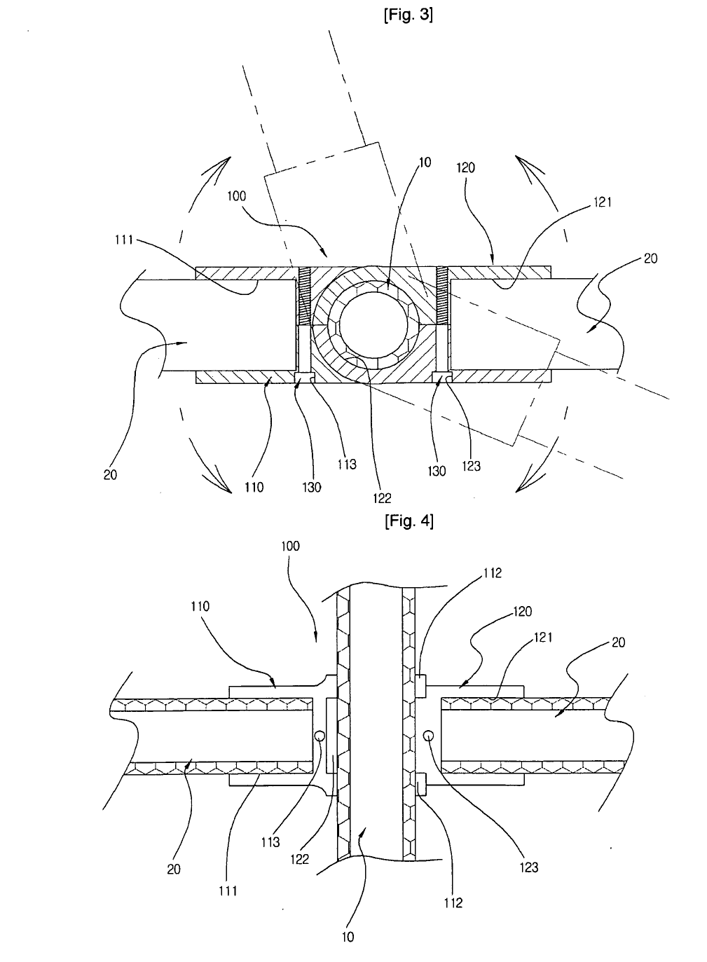

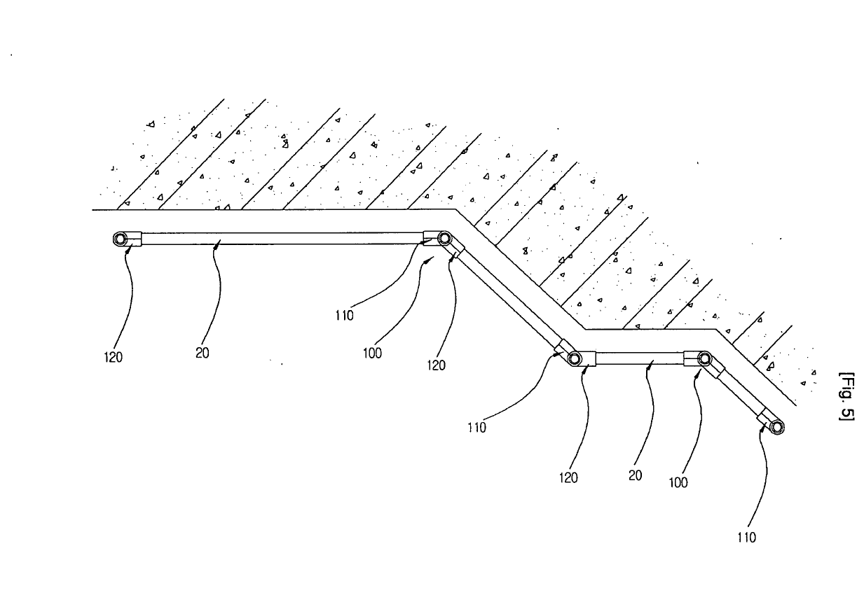

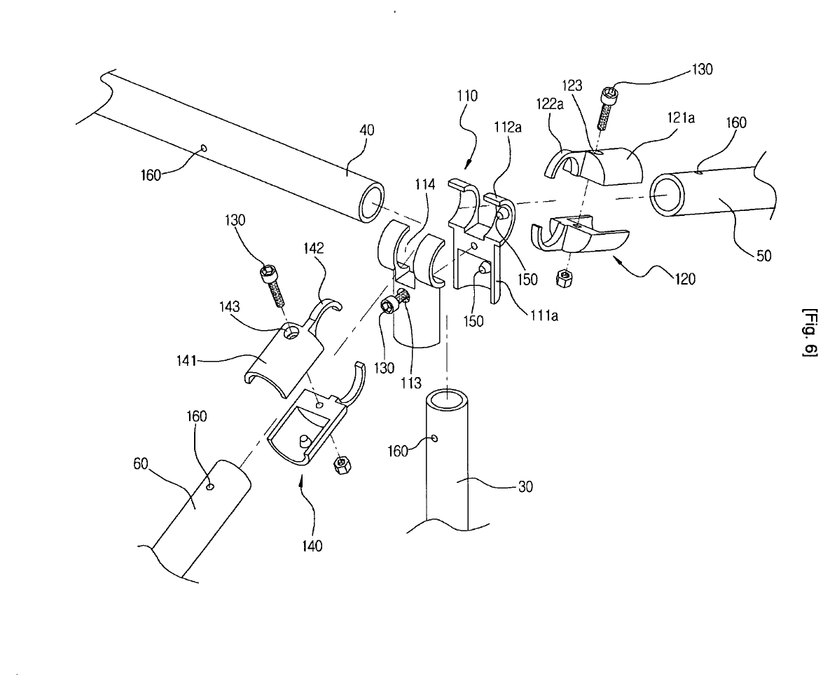

FIG. 1 is an exploded perspective view showing a fixing device for supporting sticks, according to an embodiment of the present invention, FIG. 2 is a perspective view showing the fixing device for supporting sticks of FIG. 1 in the assembled state, FIG. 3 is a front sectional view showing the fixing device for supporting sticks of FIG. 2, FIG. 4 is a plan sectional view showing the fixing device for supporting sticks of FIG. 2, and FIG. 5 is a view showing the fixing device for supporting sticks of FIG. 1, in use.

As shown in FIGS. 1 to 5, a fixing device for supporting sticks is used mainly for racks. The fixing device includes a vertical stick 10, horizontal sticks 20, a pair of first fixing units 110, a pair of second fixing units 120, and fastening means 130. In this case, the vertical stick 10 serves as a support. The horizontal sticks 20 are coupled to the vertical stick 10, and serve as a rack. The first fixing units 110 have horizontal coupling parts 111 which are in close contact with the horizontal stick 20. Vertical coupling parts 112 are provided on upper and lower portions of one end of each horizontal coupling part 111, and are in close contact with the vertical stick 10. Further, space 114 is defined between the upper and lower vertical coupling parts 112. Each of the second fixing units 120 includes a vertical coupling part 122 which is inserted into the space 114 of the corresponding fixing unit 110 and is in close contact with the vertical stick 10. A horizontal coupling part 121 protrudes outwards from the vertical coupling part 122. The fastening means 130 fastens the first fixing units 110 to each other or fastens the second fixing units 120 to each other, thus joining the horizontal sticks 20 with the vertical stick 10.

Each of the vertical stick 10 and the horizontal sticks 20 has the shape of a rod having a predetermined length. In this case, an anti-slip cap may be provided on the lower end of the vertical stick 10 to prevent the vertical stick 10 from slipping on the ground surface. Further, a frame equipped with a wheel may be secured to the vertical stick, thus allowing a rack to be conveniently moved to a desired place.

Each of the first fixing units 110 includes the horizontal coupling part 111 into which the outer circumference of the horizontal stick 20 is fitted. The vertical coupling parts 112 are provided on upper and lower portions of an end of the horizontal coupling part 111, with space 114 defined between the upper and lower vertical coupling parts 112.

Further, it is preferable that the vertical coupling parts 112 be formed to be in close contact with the outer circumference of the vertical stick 10.

Each of the second fixing units 120 includes the vertical coupling part 122 which is inserted into the space 114 of the corresponding first fixing unit 110 and is in close contact with the vertical stick 10. The horizontal coupling part 121 protrudes outwards from the vertical coupling part 122.

Preferably, the vertical coupling part 122 is slightly lower than the space 114 of the first fixing unit 110, thus allowing the angle of the vertical coupling part 122 to be smoothly adjusted when the vertical coupling part is inserted into the space.

Further, the vertical coupling parts 112, 122 comprise a pair of vertical coupling parts, and the horizontal coupling parts 111, 121 comprise a pair of horizontal coupling parts, which are provided at front and rear positions to be symmetrical with respect to each other.

In this case, each of the vertical coupling parts 112, 122 and the horizontal coupling parts 111, 121 which are provided to have symmetrical arrangement, have the shape of a half pipe.

Moreover, fastening holes 113, 123 are formed in the horizontal coupling parts 111, 121 of the fixing device 100, which are divided to be symmetrical with respect to each other. In this case, a fastening hole 113, 123 having a locking step is formed in one of the horizontal coupling parts 111, 121. Further, a fastening hole having an internal thread is formed in the horizontal coupling part 111, 121 which is symmetrical with respect to the fastening hole having the locking step.

In this case, each of the first and second fixing units 110 and 120 is manufactured through casting using a metal material which has unique luster and high ductility and malleability. However, the invention is not limited to the above-mentioned material and manufacturing method.

The fastening means 130 use general bolts. A bolt head is completely inserted into the fastening hole 113, 123 having the locking step, thus providing a good appearance to each of the horizontal coupling parts 111 and 121.

Further, each of the vertical stick 10, the horizontal sticks 20, the first fixing units 110, and the second fixing units 120 may have various shapes including polygonal shapes, such as a cylindrical shape, a triangular prism, or a square pillar, without being limited to a specific shape.

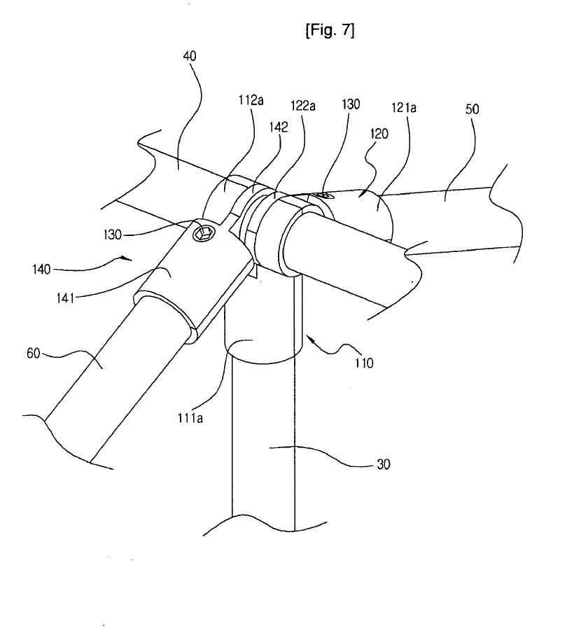

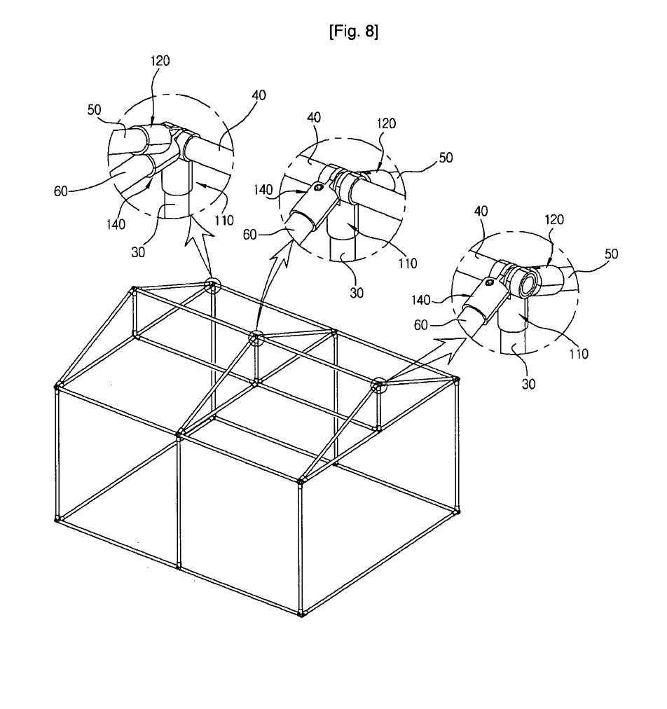

FIG. 6 is an exploded perspective view showing a fixing device for supporting sticks, according to another embodiment of the present invention, FIG. 7 is a perspective view showing the fixing device for supporting sticks of FIG. 6 in the assembled state, and FIG. 8 is a view showing the fixing device for supporting sticks of FIG. 6, in use.

As shown in FIGS. 6 to 8, in order to simultaneously insert second coupling parts 122a of a second fixing unit 120 and second coupling parts 142 of a third fixing unit 130 into corresponding space 114 of first fixing units 110, the first to third fixing units 110, 120, and 140 must be manufactured in consideration of the thickness of second coupling parts 112a of the first fixing units 110 and the thickness and positions of the second coupling parts 122a of the second fixing unit 120 and the second coupling parts 142 of the third fixing unit 140. If the thickness of the fixing units is appropriately adjusted at the time of manufacture, the second coupling parts of the fixing units inserted into the space 114 of the first fixing units 110 are not limited to this embodiment. That is, the invention may include two or more second coupling parts.

Thus, several supporting sticks 30, 40, 50, and 60 secured to the fixing units 110, 120, and 140 may be installed to have desired angles. Thereby, the applicable use of the invention may be variously expanded. That is, the invention may be used to form the framework of a wall tent, a pup tent, a vinyl house, etc. (hereinafter, collectively referred to as a tent).

Of course, when the fixing units 110, 120, and 140 are used for a tent, each fixing unit preferably comprises a pair of fixing units such that they are symmetrical with respect to each other. Preferably, fastening means 130, which are inserted into fastening holes 113, 123, and 143 to fasten each of the fixing units, comprise general bolts. As when the fixing units are used for a rack, the total thickness of the several second coupling parts 122a, 142 inserted into the space 114 of the first fixing units 110 is slightly lower than the size of the space 114 of each first fixing unit 110 such that the fixing units are rotatable to smoothly adjust the angle thereof.

Further, when the fixing device for supporting sticks according to the invention is used for a rack or tent, locking protrusions 150 are provided on the inner surfaces of the horizontal coupling parts 111 and 121 and the vertical coupling parts 112 and 122 or the inner surfaces of the first coupling parts 111a, 121a, and 141 and the second coupling parts 112a, 122a, and 142. Hence, when the fixing units are fastened using the fastening means 130, the locking protrusions 150 are inserted into locking holes 160 which are formed in the vertical stick 10 and the horizontal sticks 20 or first, second, third, and fourth supporting sticks 30, 40, 50, and 60. In this way, the vertical stick 10 and the horizontal sticks 20 or the supporting sticks 30, 40, 50, and 60 are fixed.

The operation of the present invention will be described below.

First, when the fixing device is used for a rack, the vertical coupling parts 112 of a pair of first fixing units 110 are arranged at a desired height to be in close contact with the vertical stick 10. The first fixing units 110 are preliminarily fastened to the vertical stick 10 via the fastening means 130. Meanwhile, when the fixing device is used for a tent, the second coupling parts 112a of a pair of first fixing units 110 are arranged to be in close contact with the second supporting stick 40. In such a state, the first fixing units 110 are preliminarily fastened to the second supporting stick 40 via the fastening means 130.

Next, the vertical coupling parts 122 of the second fixing units 120 are brought into close contact with the vertical stick 10. At this time, each vertical coupling part 122 is inserted into the space 114 of the corresponding first fixing unit 110 to he in close contact with the vertical stick 10, and the second fixing units 120 are preliminarily fastened. In such a state, a user rotates the first and second fixing units 110 and 120 about the vertical stick 10 to a desired angle. Meanwhile, when the fixing device is used for a tent, the second coupling parts 122a and 142 of the two or more fixing units 120 and 140 are inserted into the space 114 of the first fixing units 110 to he in close contact with the second supporting stick 40, and are preliminarily fastened. Afterwards, the fixing units are rotated at appropriate angles to allow other supporting sticks 30, 50, and 60 to be installed.

In this case, when the rotation of the fixing device 100 is completed, the horizontal sticks 20 are inserted into the horizontal coupling parts 111 and 121, and the supporting sticks 30, 50, and 60 are inserted into the first coupling parts 111a, 121a, and 141. Thereafter, the fastening means 130 which are preliminarily fastened are firmly tightened again.

In this way, the first fixing units 110 and the second fixing units 120 are rotated, and other fixing units 140 are rotated when necessary, thus appropriately adjusting the angle of the horizontal sticks 20 or the supporting sticks 30, 50, and 60.

Moreover, when a user desires to adjust the angle of the horizontal sticks 20 or the supporting sticks 30, 50, and 60 of the assembled rack or tent, the fastening means 130 provided on one of the fixing units 110, 120, and 140 is slightly loosened. In such a state, the user rotates each fixing unit at a desired angle, and adjusts the angle of the horizontal sticks 20 or the supporting sticks 30, 50, and 60.

A user may selectively use only one of the first and second fixing units 110 and 120, according to the rack installation conditions. Further, three or more fixing units may he used, according to the tent installation conditions.

In this way, a user may rotate the horizontal sticks 20 at a desired angle and adjust the height of the horizontal sticks 20 of the rack.

### INDUSTRIAL APPLICABILITY

As described above, the present invention provides a fixing device for supporting sticks, which enables free adjustment of the rotating angle of horizontal sticks, can conveniently adjust the height of the horizontal sticks, and continuously couple horizontal sticks to a vertical stick, and which allows the horizontal sticks secured to first and second fixing units to rotate at proper angles, thus being easy to install at a corner or curved surface of a wall, and which allows vertical sticks and horizontal sticks to be separated from each other, thus minimizing a volume, therefore saving money during storage and transportation.

Further, the present invention provides a multipurpose fixing device for supporting sticks, which can be applied to various structures requiring a fixing device at a joint portion, as well as to a rack, thus allowing the installation angle of the supporting sticks to be adjusted as desired, like the fixing device for the supporting sticks of the rack, and adjusting the size of a structure to be constructed.

What is claimed is:

1. A fixing device for supporting first and second horizontal sticks on a vertical support stick, comprising:
a pair of first fixing units, each comprising:
a horizontal coupling part coming into close contact with an end of the first horizontal stick; and
vertical coupling parts provided on an end of the horizontal coupling part to be located at upper and lower positions thereof, coming into close contact with the vertical support stick, and having a space defined between the upper and lower positions;
a pair of second fixing units, each comprising:
a vertical coupling part inserted into the space of each of the first fixing units, and coming into close contact with the vertical support stick; and
a horizontal coupling part coming into close contact with an end of the second horizontal stick and protruding outwards from the vertical coupling part; and
a plurality of fastening means for fastening the first fixing units to each other and fastening the second fixing units to each other, thus joining the first and second horizontal sticks with the vertical support stick.

2. A fixing device for supporting sticks, comprising:
a pair of first fixing units, each comprising:
a first coupling part coming into close contact with a first supporting stick; and
a second coupling part provided on an end of the first coupling part to come into close contact with a second supporting stick, and having a space defined thereon;
a pair of second fixing units, each comprising:
a first coupling part coming into close contact with a third supporting stick; and
a second coupling part inserted into the space of each of the first fixing units to come into close contact with the second supporting stick, the first coupling part protruding outwards from the second coupling part;
a pair of third fixing units installed at an angle different from that of the second fixing units, each of the third fixing units comprising:
a first coupling part coming into close contact with a fourth supporting stick;
a second coupling part inserted into the space of each of the first fixing units to come into close contact with the second supporting stick, the first coupling part protruding outwards from the second coupling part; and
a plurality of fastening means for fastening the first fixing units to each other, fastening the second fixing units to each other, and fastening the third fixing units to each other, thus joining the supporting sticks with each other.

3. The fixing device as set forth in claim 1, further comprising:
a locking protrusion provided on an inner surface of each of the horizontal and vertical coupling parts or an inner surface of each of the first and second coupling parts
for engaging a locking hole in each of the vertical and horizontal sticks when a fastening operation is performed using the fastening means.

4. The fixing device as set forth in claim 2, further comprising:
a locking protrusion provided on an inner surface of each of the first and second coupling parts for engaging a locking hole in each of the vertical and horizontal sticks or each of the first, second, third, and fourth sticks to correspond to the locking protrusion when a fastening operation is performed using the fastening means.
